(19) United States
(12) Patent Application Publication
(10) Pub. No.: US 2003/0182309 A1
(43) Pub. Date: Sep. 25, 2003

(54) Communication control apparatus, terminal apparatus, communication control method, and communication system

(76) Inventors: Minoru Namekata, Kawasaki-shi (JP); Tomoko Adachi, Urayasu-shi (JP); Takafumi Sakamoto, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/352,861

(22) Filed: Jan. 29, 2003

(30) Foreign Application Priority Data
Mar. 22, 2002 (JP) 2002-080065

(51) Int. Cl. G06F 7/00

(52) U.S. Cl. 707/104.1

(57) ABSTRACT

A communication priority is set for each information providing site connected to the Internet. A database in which the degrees of communication priority for the individual sites are organized in table form is provided in a network. When an user makes a request for connection to any site, the database is searched for the communication priority for the site. Then, according to the retrieved degree of connection site, the connection state of the communication channel between the user and the information providing site is controlled.

### CROSS-REFERENCE TO RELATED APPLICATIONS

This application is based upon and claims the benefit of priority from the prior Japanese Patent Application No. 2002-080065, filed Mar. 22, 2002, the entire contents of which are incorporated herein by reference.

### BACKGROUND OF THE INVENTION

1. Field of the Invention

This invention relates to a communication control apparatus and a terminal apparatus connectable to an information providing site connected to the Internet and communication control method of the communication control apparatus. The Internet provides information when a request is made for search, browsing, or the like. A communication system related to the present invention provides a communication channel that enables access to the Internet by wireless or by wire, when the user makes a request for communication.

2. Description of the Related Art

Nowadays, the number of users accessing the Internet from their offices or homes by use of personal computers is steadily increasing. The number of users accessing the Internet by use of a mobile phone or a PDA (Personal Digital Assistant) while moving from one place to another is also steadily increasing. Users access the Internet by use of information processing terminals, such as personal computers, mobile phones, or PDAs. Almost all the information processing terminals are used to carry out information processes, including information retrieval and mail reception.

Presently, nearly ten million personal computers are sold a year even in Japan alone and more than half of the Japanese people have mobile phones. The Internet is being used as a means of providing various kinds of information in both quality and quantity. More and more home pages (sites) serving as information providing windows are being set up. Recently, there have appeared carriers that provide voice service (that is, telephone service) via the Internet.

Normally, the Internet should be used as a means of offering information impartially. However, since a large number of users are using the Internet as a matter of course, the quality of information offered through the Internet is becoming important.

The most tangible problem is a rapid increase in the number of “R-rated sites.” In the Internet, since information can be offered at private level (that is, in terms of taste and interest), it is very easy to set up an “R-rated site.”

On the other hand, there are information offered to a large number of the general public free of charge by companies or the like and information offered to specific users with charge. In addition, there is information of great importance, urgency, and publicity, such as information offered to a large number of the general public by the government or a public organization. Such information is offered to users by an individual, a company, or the government via the Internet serving as a common base. Like the telephone service, services featuring the assurance of specific communication quality have started to be available.

Currently, the kinds and amount of information offered are increasing and the quality of information is diversifying. As a result, the basic concept that the Internet is an impartial information providing place and an uncontrolled information place has begun to change.

In the prior art, the order of priority of communication is not particularly set for each information providing site. Information sites unsuitable for browsing have only put up a warning notice by themselves or prevented the browsing by the filtering function based on connect destination IP addresses. Thus, an approach of controlling the communication on the basis of communication quality has not been provided. The reason for this is that access point operators and carriers cannot limit the users' requests for communication by themselves and prevent the users from finding private amusement.

With the spread of the Internet, more and more information providing sites are becoming more versatile, important, public, and urgent in an ordinary and an objective sense. The number of those sites, however, is much smaller than the number of entertainment sites. Therefore, traffic to the users connecting to entertainment sites sometimes suppresses traffic to the users connecting to sites providing important information.

With the instrumentation of ADSLs (Asymmetric Digital Subscriber Lines) realizing high-speed data communication, it is easily conceivable that the information provided by entertainment sites will become gigantic accordingly (for example, still-picture data will change to moving-picture data). Thus, it is urgent to realize the technique for controlling traffic according to the quality of the information provided.

As described above, because the basic concept of the Internet, an impartial information providing place and an uncontrolled information providing place, is maintained, this tends to cause a delay in coping with the realities of the diversity of information, the increasing volume of information, and the diversity of quality. In the prior art, the priority of communication has not been particularly set for each information providing site and communication control, such as control of communication quality, has not been realized. This has caused the disadvantage that traffic to users accessing entertainment sites degrades the quality of communication for sites of great versatility, importance, publicity, or urgency to offer information to users.

With the construction of a high-speed communication infrastructure, it is expected that the amount of information entertainment sites provide will become more enormous. Therefore, the realization of a suitable traffic control technique is a pressing need.

### BRIEF SUMMARY OF THE INVENTION

The object of the present invention is to provide a communication control apparatus, a terminal apparatus, communication control method and communication system capable of securing communication quality suitably to enable sites providing information given priority to offer information to users in the Internet starting to be disordered.

The foregoing object is accomplished by providing a communication control apparatus comprising: a priority database which stores a plurality of priorities corresponding to the sites, respectively; and control means for controlling communications between the sites and the terminal apparatuses on the basis of the priorities stored in the priority database.

With this configuration, a communication is established between the terminal apparatus the user has and a site according the state corresponding to the priority of the site. Therefore, setting high the degrees of communication priority for sites that provide information of great urgency, importance, or publicity enables the sites to provide traffic of suitable quality, which makes it possible to offer reliable information to the user quickly.

### BRIEF DESCRIPTION OF THE SEVERAL VIEWS OF THE DRAWING

FIG. 1 is a diagram to help explain an embodiment of the present invention, particularly the concept of the invention;

FIG. 2 is a diagram to help explain an embodiment of the present invention, particularly the concept of communication procedure;

FIG. 3 is a diagram to help explain FIGS. 1 and 2 in detail;

FIG. 4 is a diagram to help explain a place where a priority database is installed in an embodiment of the present invention;

FIG. 5 is a diagram to help explain another place where the priority database is installed in the embodiment;

FIG. 6 is a diagram to help explain another place where the priority database is installed in the embodiment;

FIG. 7 is a diagram to help explain another place where the priority database is installed in the embodiment;

FIG. 8 shows an embodiment of information managed using a priority database according to the present invention;

FIG. 9 is a flowchart for the communication procedure using a wireless channel in communication control method according to the present invention;

FIG. 10 is a flowchart for an example of the process of updating the priority database according to an embodiment of the present invention;

FIG. 11 is a flowchart for an example of the process of updating the priority database in communication control method according to the present invention;

FIGS. 12A and 12B show examples of the contents of a priority database according to an embodiment of the present invention;

FIG. 13 is a flowchart showing an embodiment of the procedure for informing the user of the communication priority of the site;

FIG. 14 is a schematic diagram showing an embodiment of an approach of informing the user of the communication priority according to the present invention;

FIG. 15 is a flowchart showing an example of the processing procedure when a plurality of users make a connection request;

FIG. 16 is a flowchart showing another example of the processing procedure when a plurality of users make a connection request; and

FIG. 17 is a flowchart showing still another example of the processing procedure when a plurality of users make a connection request.

### DETAILED DESCRIPTION OF THE INVENTION

Hereinafter, referring to the accompanying drawings, an embodiment of the present invention will be explained.

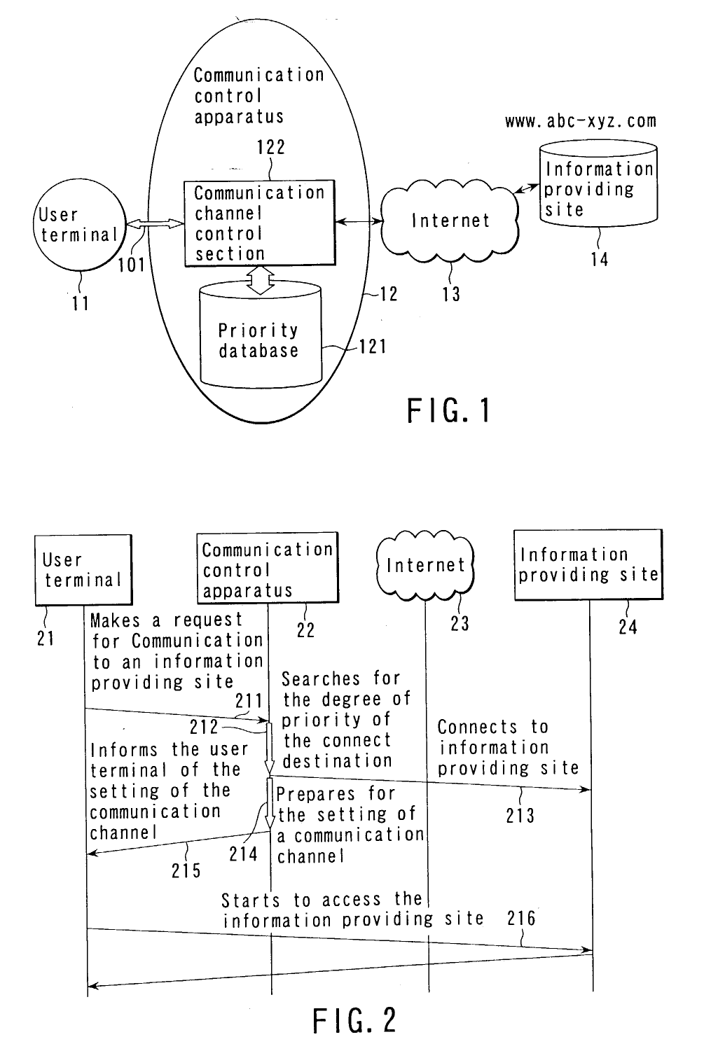

FIG. 1 is a diagram to help explain an embodiment of the present invention, particularly the concept of the invention. FIG. 1 shows the way an user terminal 11 connects to an information providing site (hereinafter, referred to as a site) 14 via a communication control apparatus 12 and the Internet 13. As everyone knows, the Internet 13 provides an information communication environment, using TCP/IP. The user terminal 11 is connected to the communication control apparatus 12 via a wireless or wire communication channel 101. The communication channel 101 may be prepared by an user himself or herself who has the user terminal 11 or provided by a carrier that manages and operates the communication control apparatus 12.

The user terminal 11 sends a request for communication to the site 12 via the communication channel 101. Then, a communication channel control section 122 in the communication control apparatus 12 refers to a priority database 121 for a communication priority of the site 14, a connect destination. The communication channel control section 122 controls communication between the user terminal 11 and the site 14 according to the priority recorded in the priority database 121.

Such a configuration and a series of processes realize communication priority control between the user terminal 11 and the site 14. That is, it is possible to perform communication control in which a communication priority is given to each of the sites to which users request to be connected. This enables sites of great urgency, importance, and publicity whose communication priority should be set high to provide the users with information of suitable quality reliably.

FIG. 2 is a diagram to help explain the communication procedure in communication control method in the present invention. First, the user terminal 21 makes a request to the communication control apparatus 22 for communication to the site 24 (step 211). Then, the communication control apparatus 22 searches for the communication priority of the connect destination (step 212) and, on the basis of the result of the search, connects the channel to the site 24 (step 213). Then, the communication control apparatus 22 prepares the setting of a communication channel for the user terminal 21 (step 214) and informs the user terminal 21 of the setting of the communication channel (step 215). After the above procedure, the user terminal 21 starts to access the site 24 (step 216). The communication with the controlled channel is maintained until the delivery of the information to the user terminal 21 has been completed.

By the series of processes, communication can be made to the sites connected to the Internet which are capable of providing information in information retrieval or browsing, according to the communication priority of each site to which the user wants to connect. Therefore, for example, an site of great urgency, importance, and publicity whose communication priority should be set high can provide information of suitable quality reliably.

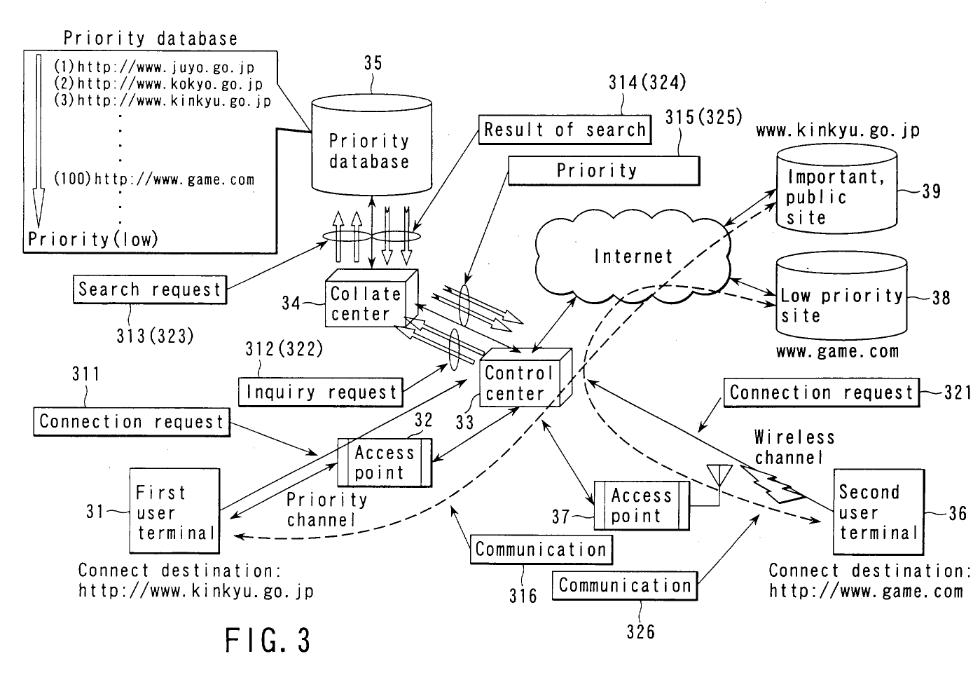

FIG. 3 is a diagram to help explain the details of FIGS. 1 and 2 in the communication system of the invention.

A first user terminal 31 is an user terminal connected to a wire communication channel. The first user terminal 31 makes a request 311 to a control center 33 in the communication system via an access point 32 for communication to an site 39 with a URL (Uniform Resource Locater), such as “http://www.kinkyu.go.jp.”. The control center 33 makes a collate request 312 to a collate center 34 for search of the priority of the destination to which the first user 32 wants to connect. In the collate center 34, a degree-of-priority database 35 has been constructed. Receiving the collate request 312, the collate center 34 makes a search request 313 to the priority database 35.

In the degree-of-priority database 35, the priority of the site 39 to which the first user terminal 31 wants to connect has been registered. The degree-of-priority database 35 returns the result of the search 314 to the collate center 34. The collate center 34 informs the control center 33 of the retrieved priority 315. Here, it is assumed that the priority of the site 39 is the third degree. The control center 33 controls the communication channel between the first user terminal 31 and the connect destination site 39 according to the notified priority 315 and establishes communication 316.

A second user terminal 36 is an user terminal connected to a wireless communication channel. The second user terminal 36 makes a request 321 to the control center 33 in the communication system via an access point 37 for communication to an site 38 with a URL, such as “http://www.game.com.”. The control center 33 makes a collate request 322 to the collate center 34 for search of the priority of the destination to which the second user terminal 36 wants to connect. Receiving the collate request 322, the collate center 34 makes a search request 323 to the priority database 35.

In the degree-of-priority database 35, the priority of the site 38 to which the second user 32 wants to connect has been registered. The degree-of-priority database 35 returns the result of the search 324 to the collate center 34. The collate center 34 informs the control center 33 of the retrieved priority 325. Here, it is assumed that the priority of the site 38 is the hundredth degree. The control center 33 controls the communication channel between the second user terminal 36 and the connect destination site 38 according to the notified priority 325 and establishes communication 326.

The priority of communication 326 is lower than the priority of communication 316 already set between the first user terminal 31 and the site 39. Therefore, communication 326 may not be set, depending on the condition of communication on the Internet.

By carrying out the series of processes for each user, communication can be made to the sites connected to the Internet which are capable of providing information in information retrieval or browsing, according to the communication priority of each site to which the user wants to connect. Therefore, for example, an site of great urgency, importance, and publicity whose communication priority should be set high can provide information of suitable quality reliably, giving priority to the relevant user over other users connected to the site.

In the embodiment, the communication priority of each connect destination site shown in FIGS. 1 and 3 are managed by use of the degree-of-priority databases 121 and 35. This enables network operators, carriers, or users themselves to manage the databases intensively and easily.

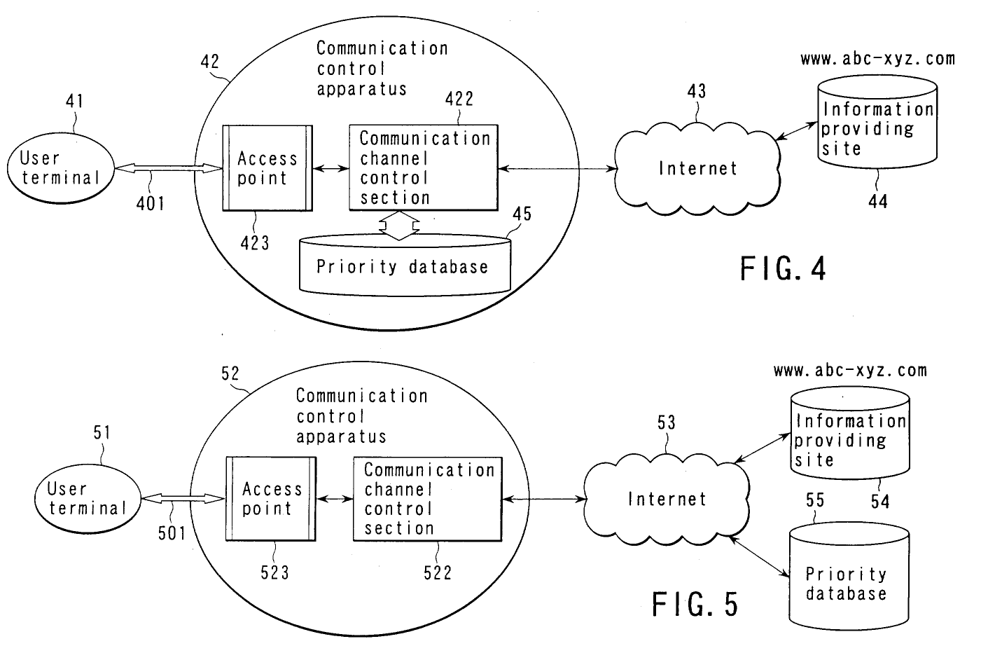

FIG. 4 shows an embodiment to help explain a place where a priority database is installed in a communication system according to the present invention. FIG. 4 shows the way an user terminal 41 connects to an site 44 by way of an access point 423 in a communication control apparatus 42 and the Internet 43.

The priority database 45 is connected to a communication channel control section 422. The communication channel control section 422 is provided closer to the Internet than to the access point 423 in the communication control apparatus 42. When the user terminal 41 makes a request for communication to the site 44, the priority database 45 is referred to for the communication priority of the site 44. The communication channel control section 422 controls the communication channel according to the priority recorded in the priority database 45.

As described above, providing the function of managing the priority by use of the database (DB) in the network enables the network operator or carrier to manage the database (DB) collectively. This has the merit of preventing irresponsible users from carrying out processes or making registrations illegally.

FIG. 5 shows another embodiment related to an installation location for a priority database in the communication system according to the invention. FIG. 5 shows the way an user terminal 51 connects to an site 54 by way of an access point 523 in a communication control apparatus 52 and the Internet 53.

When the user terminal 51 makes a request for communication to the site 54, a communication control section 522 in the communication control apparatus 52 refers to a priority database 55 connected to the Internet 53 for the communication priority of the connect destination site 54. Then, the communication channel control section 522 controls the communication channel according to the priority recorded in the priority database 55.

As described above, providing the database (DB) for managing the priority on the network side enables the network operator or carrier to manage the database collectively. This has the merit of preventing malicious users from carrying out processes or making registrations illegally. Furthermore, the connect destination database may be shared by a plurality of carriers.

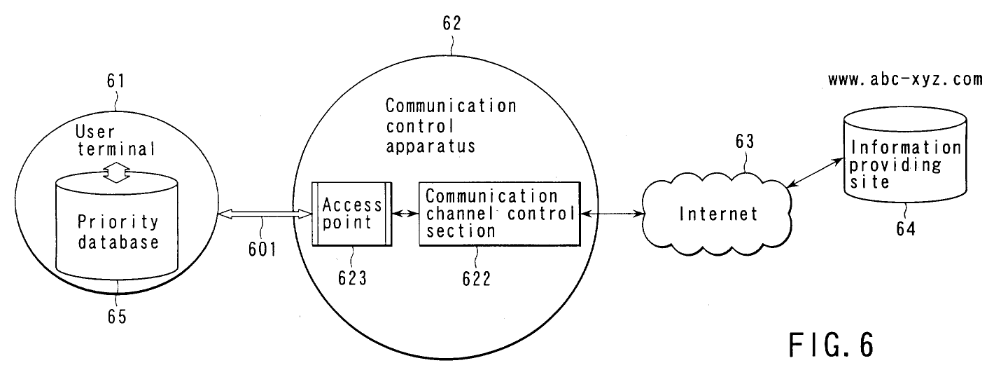

FIG. 6 shows another embodiment related to an installation location for a priority database in the communication system according to the invention. FIG. 6 shows the way an user terminal 61 connects to an site 64 by way of an access point 623 in a communication control apparatus 62 and the Internet 63.

In FIG. 6, a priority database 65 is provided in the user terminal 61 and is managed by the user. Before sending a request for communication to the site 64 to the communication control apparatus 62, the user terminal 61 accesses the priority database 65 and refers to the database 65 for the communication priority of the site 64. The priority database 65 retrieves the communication priority of the site 64 and returns the result of the retrieval to the user terminal 61. The user terminal 61 specifies the returned communication priority and makes a connection request to a communication channel control section 622 in the communication system via an access point 623 in the communication control apparatus 62. The communication channel control section 622 controls the communication channel with the site 64 according to the communication priority.

As described above, providing the database on the user side enables the management burden on the network operator or carrier to be decreased. Furthermore, part of the work of updating the database can be shared by the user. It is desirable that information about the communication priority should be stored in the range that allows the user to manage the database privately.

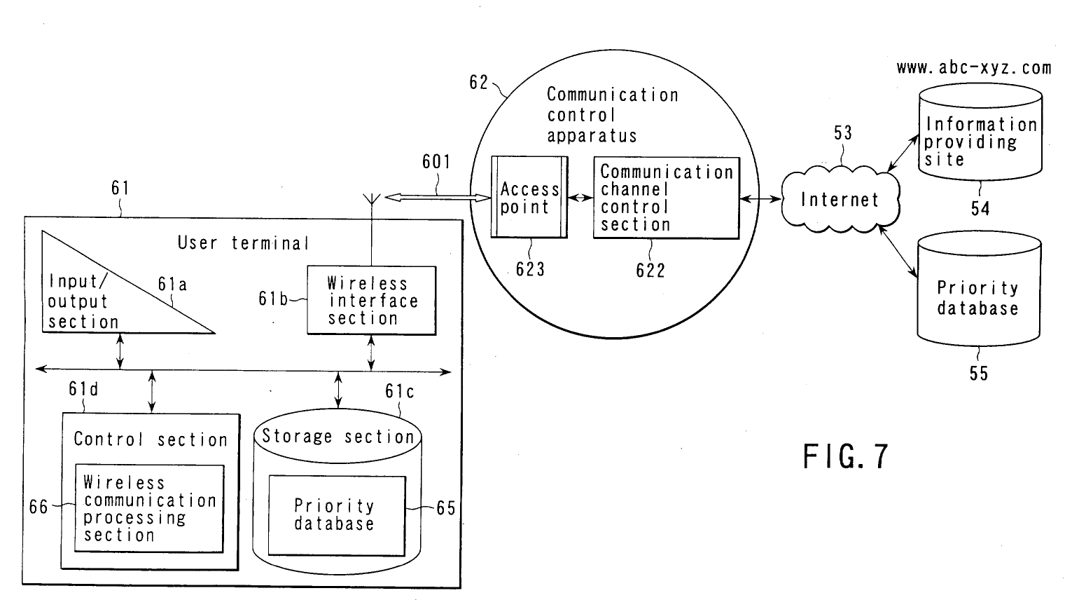

FIG. 7 shows another embodiment related to an installation location for a priority database in the communication system according to the invention. FIG. 7 shows a state where a priority database is provided on each of the network side and the user side. Particularly in the user terminal 61, the degree-of-priority database 65 is stored in a storage section 61c, such as a semiconductor memory.

With this configuration, the priority of communication to important sites of great publicity and urgency or sites of ordinary companies should be managed by use of the degree-of-priority database 55 on the network side. On the other hand, the priority of communication to personal sites or vulgar sites should be managed by use of the degree-of-priority database 65 on the user side. The degree-of-priority database 55 should be updated by the network operator or carrier. The degree-of-priority database 65 should be updated by the user terminal 61.

The process of matching the contents of the degree-of-priority database 55 with the contents of the degree-of-priority database 65 may be carried out in, for example, software. When such a process is not carried out, the contents of the degree-of-priority database 55 should be allowed to take priority over the contents of the degree-of-priority database 65.

FIG. 7 shows the configuration of a user terminal 61 for establishing a wireless channel 601 between an access point 623 and the user terminal 61. The user terminal 61 includes an input/output section 61a, a wireless interface section 61b, the storage section 61c, and a control section 61d.

The input/output section 61a includes a display and a keypad (which are not shown). The wireless interface section 61b, which includes an antenna 67, establishes a wireless channel 601 with the access point 623. A system based on the wireless LAN standard for, for example, IEEE802. 11b or the same series is applied to the interface for the wireless section. The storage section 61c stores the priority database 65. The control section 61d includes a wireless communication processing section 66. The wireless communication processing section 66 does calculations for establishing the wireless channel 601 by, for example, carrying out a software process.

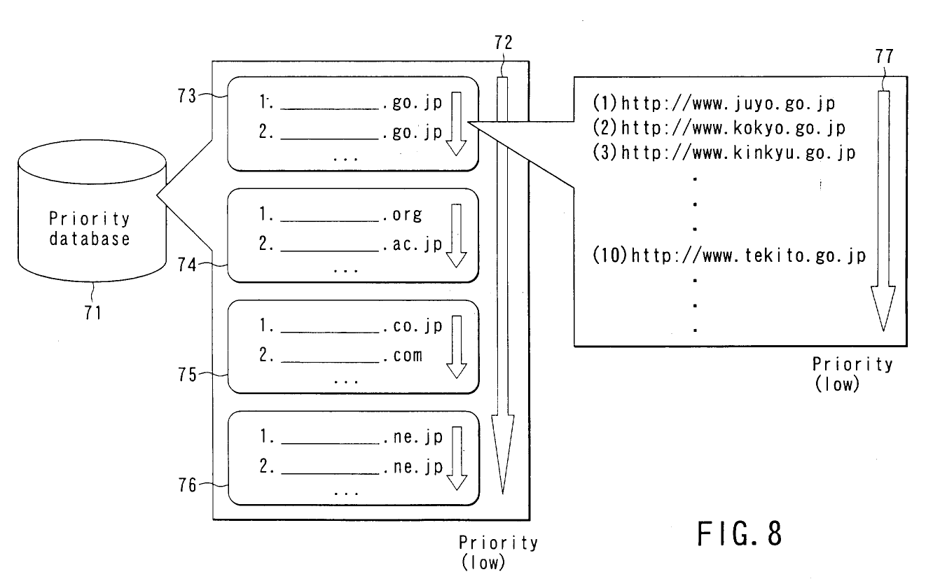

FIG. 8 shows an embodiment of information managed by use of a priority database according to the present invention. In this embodiment, sites are divided into four categories differing in priority (73 to 76). The URLs for the sites are registered in each of the categories 73 to 76 of the priority database 71.

Public sites of great publicity or urgency, such as “http://www.---.go.jp”, are registered in the category 73 with the highest priority. Sites for educational facilities, including university, or public corporations, such as “http://www.---.or.jp” or “http:www.---.ac.jp”, are registered in the category 74 with the second highest priority.

Sites for ordinary corporations, such as “http://www.---.co.jp” or “http:www.---.com”, are registered in the category 75 with the third highest priority. Sites for individuals, such as “http:www.---.ne.jp”, are registered in the category 76 with the lowest priority.

Furthermore, in the embodiment, a priority is determined for a URL in each of the categories 73 to 76. For example, the priority of “http://www.juyo.go.jp” is higher than “http://www.kokyo.go.jp”. As described above, when the degrees of communication priority are managed over two steps, a site providing information of greater importance or urgency has a higher priority. Since the priority of a site that provides important, urgent, public information is set high for a large number of the general public, users can receive information without stress if an emergency arises.

FIG. 8 show the way an URL, one of the attributes of a site, is registered in the priority database 71. Instead of this, the Internet protocol (IP) address for the site may be registered in the priority database 71. Registering URLs or IP addresses in this way makes it easy to match the attribute of a connect destination with the priority of the destination when a Web browser sends a request for communication to the site.

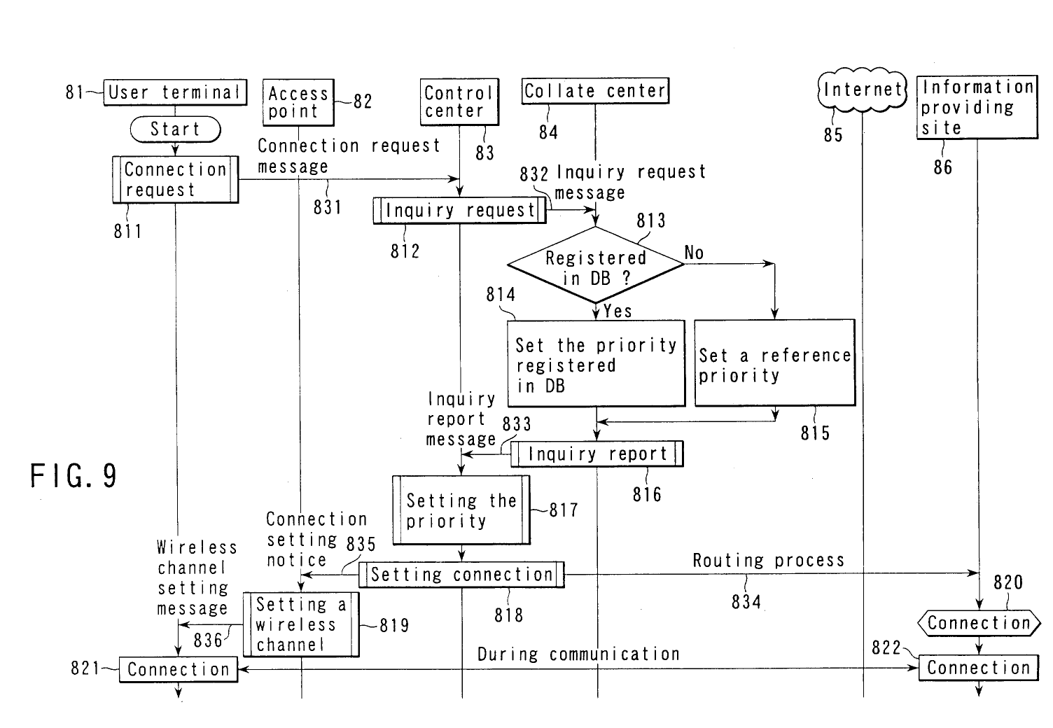

FIG. 9 is a flowchart for the communication procedure using a wireless channel in communication control method according to the present invention. FIG. 9 particularly shows an example of the procedure when the destination to which the user wants to connect has not been registered in a degree-of-priority database.

When an user terminal 81 makes a request for communication to a site 86 (step 811), a connection request message 831 passes through an access point 82 and reaches a control center 83. Receiving the connection request message 831, the control center 83 makes an inquiry request 812 to a collate center 84. Receiving the inquiry request message 832 from the control center 83, the collate center 84 starts to search process in the priority database.

If degree-of-priority information on the site 86 has been registered in the priority database, the priority based on the contents of the registration is the result 814 of the search (step 814). If degree-of-priority information on the site 86 has not been registered in the priority database, a previously defined reference value is set as the result 815 of the search (step 815). The collate center 84 informs the control center 83 of the result of the inquiry (step 816).

Receiving the collation report message 833 from the collate center 84, the control center 83 sets the communication priority (step 817). The control center 83 starts to set the communication between the user terminal 81 and the site 86 according to the setting (step 818).

The control center 83 may serve as if it were a proxy server. In this case, the control center 83 not only carries out a routing process by way of the Internet 85 to the site 86 (834) but also sends a connection setting notice 835 to the access point 82.

The access point 82, receiving the connection setting notice 835, sets a wireless channel for the user terminal 81 (step 819) and sends a wireless channel setting message 836 to the user terminal 81. Receiving this message, the user terminal 81 carries out a channel connection process (step 821). At this time, the site 86 prepares for connection (step 820) and then carries out a connection process (step 822). By the above procedure, communication based on the communication priority can be made between the user terminal 81 and the site 86.

Even if the user wants to connect to a site not registered in the priority database, it is possible to prevent the connection process from being delayed, since a reference value is set for the priority of communication to the site. Taking advantage of the opportunity to connect such an unregistered site, the priority of the unregistered connect destination may be registered in the database automatically or manually.

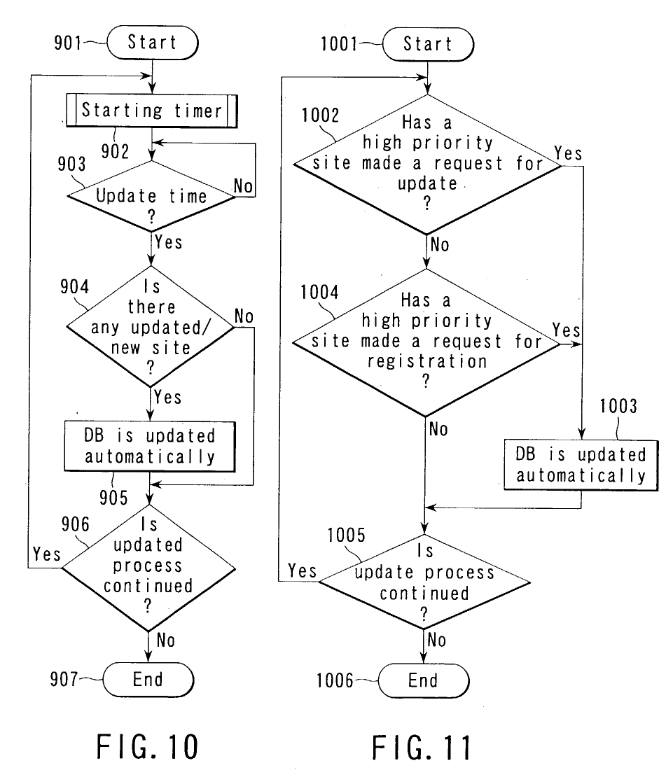

FIG. 10 is a flowchart for the process of updating the priority database in communication control method according to the present invention. FIG. 10 particularly shows the procedure for updating the priority database automatically and regularly.

When the updating process is started (step 901), a timer is started (step 902). The value of the timer is monitored and the arrival of the update time is determined (step 903). When the update time of the priority database has been reached, the presence or absence of a newly opened or updated site is checked (step 904). If the presence of a site whose registration needs updating is confirmed, the priority database is updated (step 905).

In the above procedure, an unquestionable site with such a URL as “***.go.jp” (corresponding to a governmental site) or “***.gov” (corresponding to a nonprofit institution (or corporation)) is sensed automatically. Then, the registration of the site is updated.

After step 905, it is determined whether the update process is continued (step 906). If the update process is continued, the processing procedure returns to step 902, where the timer is started again.

By such the processing procedure, the database (DB) that manages the communication priority is updated regularly, with the result that the communication priority of the site newly opened or updated is updated timely. This prevents information from being offered with an unsuitable priority or unsuitable quality.

FIG. 11 is a flowchart for the process of updating the priority database in communication control method according to the present invention. FIG. 11 particularly shows the procedure for carrying out the update process by using the updating or a new registration of a high priority site as a trigger.

When the update process is started (step 1001), it is determined whether a high degree-of-priority site has made a request for updating the priority database (step 1002). If a high degree-of-priority site has made such an update request, the priority database is updated automatically (step 1003).

If a high degree-of-priority site has not made such an update request, it is determined whether a high degree-of-priority site has made a new request for registering in the priority database (step 1004). As a result, if a high degree-of-priority site has made such a new request, the priority database is updated automatically (step 1003).

If a high degree-of-priority site has not made such a new request, it is determined after step 1003 whether to carry out the update process continuously (step 1005). Then, the wait state lasts until an update request or a new registration request is made.

By the above procedure, when a site that provides information of great importance, urgency, or publicity is opened or updated, the priority for the site is newly registered or updated. This process is carried out automatically. This prevents the work of registering in the priority database from becoming complicated, which improves the user's convenience.

In the processes of FIGS. 10 and 11, the update process is carried out automatically and regularly. Instead of this, the priority database may be updated only when the user makes a request for updating the priority.

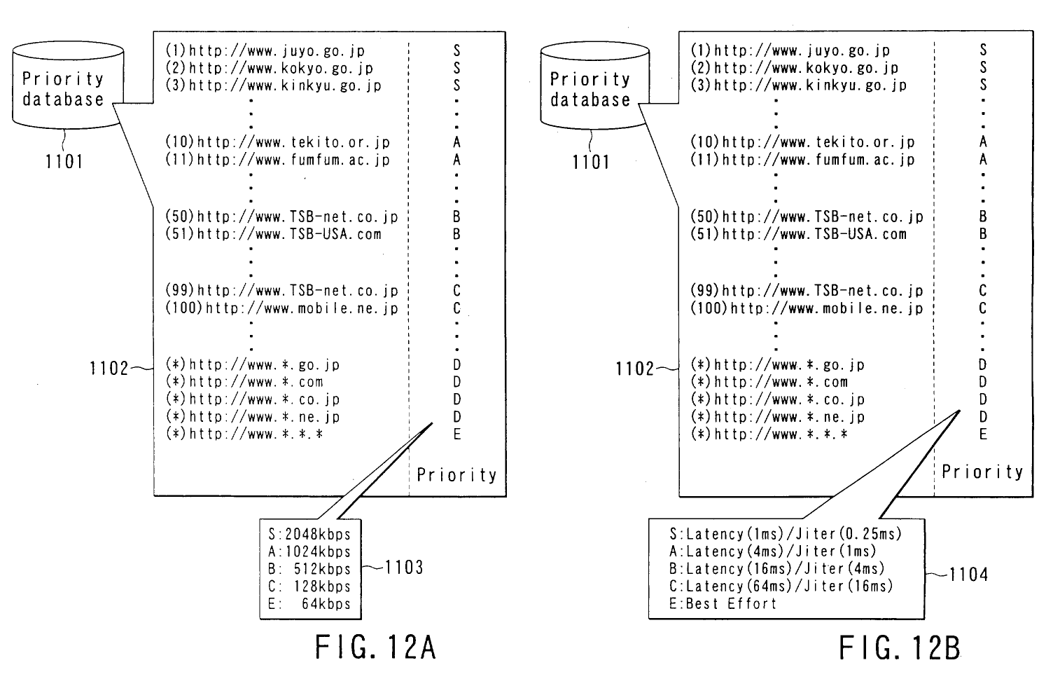

FIGS. 12A and 12B show examples of the contents of a priority database according to the present invention. FIGS. 12A and 12B differ from FIG. 8 in that the contents of uncategorized database are shown.

In FIGS. 12A and 12B, sites are registered in the contents 1102 of a priority database 1101 in descending order of the degree of communication priority. Each site has the priority ranging from S rank to E rank. In FIGS. 12A and 12B, a URL expressed using a wild card is registered with a low priority. For example, “http://*.com” and “http://*.ne.jp” are categorized as D rank and “http://*.*” is categorized as E rank. Expressing URL by a wild card enables a plurality of sites to be managed simultaneously. A URL expressed using a wild card means that the connect destination is particularly not limited. That is, it is possible to manage even a site whose connect destination is particularly not limited.

In a table shown in FIG. 12A, a transmission speed (or band) is caused to correspond to each rank of priority. Reference numeral 1103 in the figure shows a transmission speed for each rank. Assuring the transmission speed for each rank of priority for sites makes it possible to make constant the speed at which information is obtained from the sites, which realizes a smooth acquisition of information. Allocating a high-speed transmission speed to a high-rank site enables the user to receive important information quickly without stress.

In a table shown in FIG. 12B, QoS (Quality of Service) is caused to correspond to each rank of priority. Reference numeral 1104 in the figure shows QoS for each rank. Assuring QoS for each priority for sites makes it possible to maintain constant the quality of information acquired from the sites. Allocating a high QoS to a high-rank site enables a stable channel with a short delay and a small jitter characteristic to be used in browsing important information, which realizes the offering of information with a high communication quality. A low-rank site offers information inferior in quality with large variations.

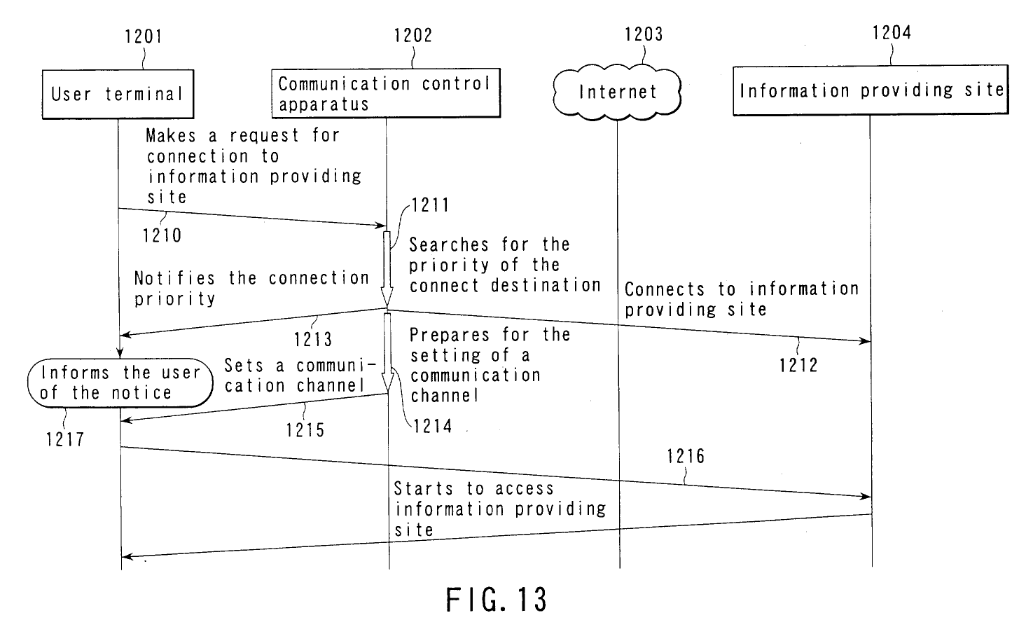

FIG. 13 is a flowchart to help explain an embodiment of the procedure for informing the user of the priority of a site according to the present invention. An user terminal 1201 makes a request 1210 to a communication control apparatus 1202 for communication to a site 1204, by way of the Internet 1203. The communication control apparatus 1202 searches for the communication priority of the site 1203 (step 1211). Then, the communication control apparatus 1202 connects a channel to the site 1204 with the priority according to the result of the search (step 1212) and notifies the communication priority to the user terminal 1201 (step 1213). The user terminal 1201 informs the user of the notice in an auditory or visual manner (step 1217).

The communication control apparatus 1202 prepares for the setting of a communication channel for the user terminal 1201 (step 1214) and then informs the user terminal 1201 of the setting of the communication channel (1215).

By the above processes, the user terminal 1201 can access the site 1204 by using the channel subjected to communication control (step 1216). This channel is maintained until the offering of information is completed. Informing the user of the communication priority enables the user to recognize what status communication has been set.

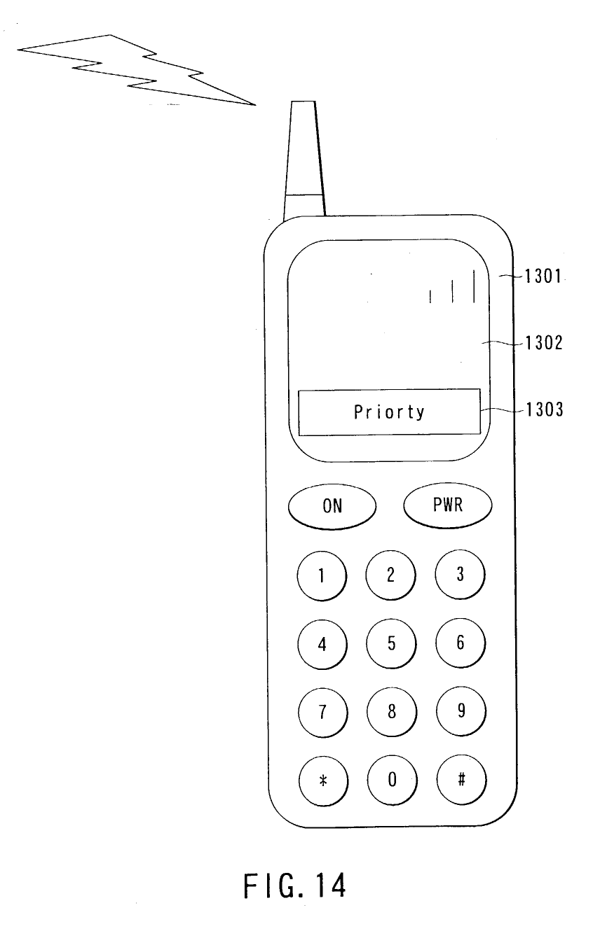

FIG. 14 is a schematic diagram of an embodiment of a method of informing the user of the degree of communication priority. Reference numeral 1301 indicates a portable terminal the user has. In this embodiment, the priority 1303 of communication to a site is caused to appear on a display 1302 of the portable terminal 1301. This enables the user who has sent a connection request to recognize what status communication has been set.

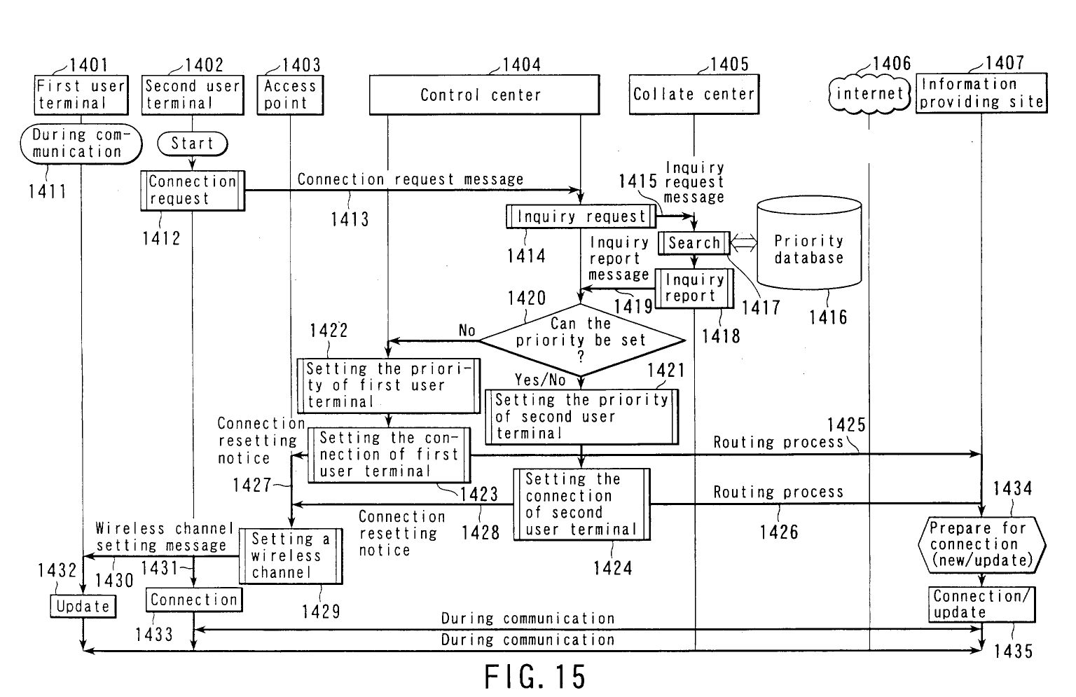

FIG. 15 is a flowchart for the processing procedure when a plurality of users make a connection request. It is assumed that the communication priority of a second user terminal 1402 is higher than that of a first user terminal 1401.

FIG. 15 shows a state where the first user terminal 1401 and the second user terminal 1402 are under the control of the same access point 1403. Alternatively, the individual user terminals 1401, 1402 may pass through different access points. Although FIG. 15 shows a state where both of the user terminals 1401, 1402 are connected to the same site 1407, the same procedure holds true even when the individual user terminals 1401, 1402 are connected to different access points.

It is assumed that the first user terminal 1401 has already communicated with the site 1407 according to the communication procedure shown in FIG. 9. In this state, when the second user terminal 1402 makes a request for communication to the site 1407 (step 1412), a connection request message 1413 passes through the access point 1403 and reaches the control center 1404.

Receiving the connection request message 1413, the control center 1404 requests a collate center 1405 to inquire a priority (step 1414). The collate center 1405 receives a collate request message 1415 from the control center 1404. Then, the collate center 1405 searches the priority database 1416 for the communication priority of the site to which the second user terminal 1402 wants to connect (step 1417). After finishing the search, the collate center 1405 informs the control center 1404 of the result of the inquiry (step 1418).

The control center 1404 receives an inquiry report message 1419 from the collate center 1405 and determines whether the priority of communication to the site to which the second user terminal 1402 wants to connect can be realized (step 1420).

The communication priority of the second user terminal 1402 is higher than that of the first user terminal 1401. Therefore, if the communication priority were applied to the second user terminal 1402, the communication priority of the first user terminal 1401 who has already been communicating could not be fulfilled. To avoid this problem, the priority of the second user terminal 1402 is set first (step 1421) and then the priority of the first user terminal 1401 is set again (step 1422). After the priority for each user terminal set again, the communication of the first user terminal 1401 is set again (step 1423) and then the communication of the second user terminal 1402 is set (step 1424).

The control center 1404 may be a proxy server. In this case, the control center 1404 not only carries out the process of taking its route to the site 1407 by way of the Internet 1406 (steps 1425, 1426) but also sends a connection resetting notice 1427 and a connection setting notice 1428 to the access point 1403.

Receiving both of the notices 1427, 1428, the access point 1403 sets wireless channels for the first user terminal 1401 and second user terminal 1402 (step 1429). Then, the access point 1403 sends wireless channel setting messages 1430 and 1431 to the first user terminal 1401 and second user terminal 1402, respectively.

The first user terminal 1401 receives the wireless channel setting message 1430 and carries out an update process related to resetting (step 1432). The second user terminal 1402 receives the wireless channel setting message 1431 and carries out a connection process (step 1433). The resetting of the wireless channel may not be needed when the priority of communication to the first user terminal 1401 is reset. In such a case, the wireless channel setting message 1430 is unnecessary.

The site 1407 prepares for (updated/new) connection with the first user terminal 1401 and second user terminal 1402 (step 1434) and carries out a connection/update process (step 1435).

By such processes, the communication of the first user terminal 1401 to the site 1407 is updated and the second user terminal 1402 is newly connected to the site 1407. A communication channel with the same communication priority as the allocated one is set for the second user terminal 1402. A communication cannel with a little lower communication priority than the allocated one is set for the first user terminal 1401.

That is, when degrees of communication priority for a plurality of users concur, the communication channel for an user with a low priority is reset with a lower priority, which enables a plurality of users to connect to the sites. By doing this, the second user terminal 1402's request to receive information from a connect destination with a high communication priority can be satisfied. Although the first user terminal 1401 undergoes a little drop in the priority, the disconnection of the channel can be avoided.

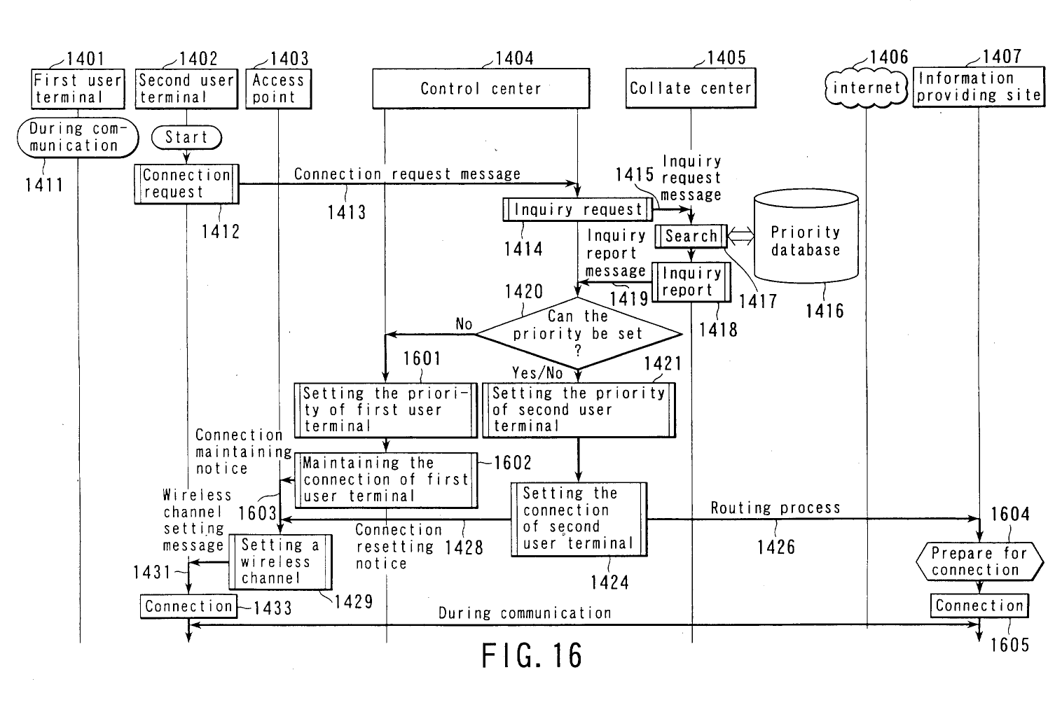

FIG. 16 is a flowchart for another processing procedure when a plurality of users make a connection request. In contrast with FIG. 15, it is assumed that the communication priority of the first user terminal 1401 is higher than that of the second user terminal 1402. In FIG. 16, the same procedures and messages as those in FIG. 15 are indicated by the same reference numerals and only the parts differing from those in FIG. 15 will be explained.

In FIG. 16, the first user terminal 1401 has already been communicating. In this state, after the second user terminal 1402 makes a request for communication to the site 1407 (step 1412), an inquiry report message 1419 is given to the control center 1404 (step 1418). The control center 1404 determines whether the communication priority of the second user terminal 1402 can be set for the site 1407 (step 1420).

The communication priority of the first user terminal 1401 is higher than that of the second user terminal 1402. Therefore, the communication priority of the first user terminal 1401 is maintained (step 1601) and the priority of the second user terminal 1402 is set (step 1421). The communication of the first user terminal 1401 is maintained, with the communication priority remaining unchanged (step 1602). The communication of the second user terminal 1402 is set according to the set communication priority (step 1424).

The control center 1404 gives a connection maintaining notice 1603 and a connection setting notice 1428 to the access point 1403.

Receiving the connection maintaining notice 1603 and connection setting notice 1428, the access point 1403 sets a wireless channel for the second user terminal 1402, while maintaining the wireless channel with the first user terminal 1401 (step 1429). The access point 1403 gives a wireless channel setting message 1431 to the second user terminal 1402 (step 1429).

Receiving the wireless channel setting message 1431, the second user terminal 1402 connects a channel (step 1433). The site 1407 prepares for communication with the second user terminal 1402 (step 1604) and connect a channel (step 1605).

By such processes, the second user terminal 1402 is newly connected to the site 1407, with the communication of the first user to the site 1407 maintained. The communication priority of the first user terminal 1401 is maintained at the same degree before the second user terminal 1402 is connected to the site 1407. This enables a connection request made by the second user terminal 1402 to be compatible with the communication of the first user terminal 1401 without the request being rejected.

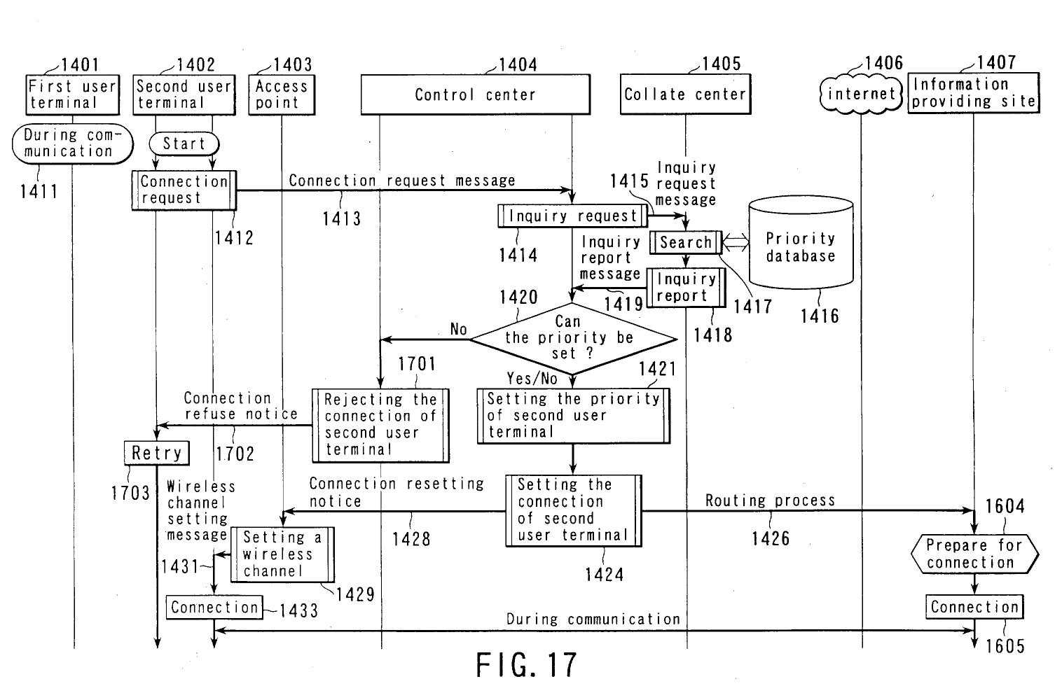

FIG. 17 is a flowchart for another processing procedure when a plurality of users make a connection request. In FIG. 17, the same procedures and messages as those in FIGS. 15 and 16 are indicated by the same reference numerals and only the parts differing from those in FIGS. 15 and 16 will be explained.

In the procedure of FIG. 17, the communication of the user who has already been communicating is given priority, regardless of whether the communication priority of the first user terminal 1401 is higher than that of the first user terminal 1402 or vice versa. That is, when a plurality of users make a connection request, a connection request made later by an user is rejected. A case where the second user terminal 1402 makes a connection request in a state where the first user terminal 1401 has already been communicating will be explained.

In step 1420 of FIG. 17, it is determined that the communication priority of the second user terminal 1402 is not set. According to the determination, the control center 1404 rejects the connect request made by the second user terminal 1402 (step 1701). In this step, the control center 1404 sends a connection refuse notice 1702 to the second user terminal 1402. As a result of this, the communication priority of the first user terminal 1401 that has already been communicating is maintained.

The second user terminal 1402, receiving the connection refuse notice 1702, may make tries until communication is established (step 1703) or give up communication. When the communication priority of the second user terminal 1402 is high, it is determined in step 1420 that the communication of the second user terminal 1402 is possible and the same processing procedure as in FIG. 15 or 16 is carried out.

By such processes, when the second user terminal 1402 (with a low degree of communication priority) makes a connection request in a state where the first user terminal 1401 (with a high degree of communication priority) is receiving information from the site 1407, a connection request made by the second user terminal 1402 is rejected. This prevents the communication state of the first user terminal 1401 from being suppressed, which prevents the quality of service to the first user terminal 1401 from deteriorating or becoming unstable.

The present invention is not limited to the above embodiments. For instance, the way of categorizing sites as shown in FIG. 8 is one example and they are not necessarily categorized. Furthermore, while in FIGS. 9, 15, and 16, the user has used a wireless channel, a similar processing procedure may be applied to a case where a wire channel is used.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication control apparatus provided between a communication network and a plurality of terminal apparatuses which access a plurality of sites connected to the communication network by sharing communication resources of the communication network, the communication control apparatus comprising:
a priority database which stores a plurality of priorities corresponding to the sites, respectively; and
control means for controlling communications between the sites and the terminal apparatuses on the basis of the priorities stored in the priority database.

2. The communication control apparatus according to claim 1, further comprising:
an access point which provides the terminal apparatuses with a physical communication channel for communicating with the communication network, wherein the priority database is provided closer to the communication network than the access point.

3. The communication control apparatus according to claim 2, wherein the communication channel is a wireless channel.

4. The communication control apparatus according to claim 2, wherein the communication channel is a wire channel.

5. The communication control apparatus according to claim 1, wherein the priority database is provided in the terminal apparatuses.

6. The communication control apparatus according to claim 1, wherein the control means controls the transmission speed of the communications on the basis of the priority stored in the priority database.

7. The communication control apparatus according to claim 1, wherein the control means controls the QoS (Quality of Service) of the communications on the basis of the priority stored in the priority database.

8. The communication control apparatus according to claim 1, wherein the communication network provides an information communication environment using TCP/IP (transmission control protocol/internet protocol).

9. The communication control apparatus according to claim 1, wherein the priority are stored by the URL (Uniform Resource Locater) in the priority database.

10. The communication control apparatus according to claim 1, wherein the priority are stored by category in the priority database, the categories differing in the priority.

11. A terminal apparatus which access a plurality of sites connected to the communication network by sharing communication resources of the communication network, the terminal apparatus comprising:
a priority database which stores a plurality of priorities corresponding to the sites, respectively; and
sending means for sending a request for the connections with the sites on the basis of the priorities stored in the priority database.

12. The terminal apparatus according to claim 11, further comprising wireless communication means for, when an access point is provided between the communication network and a plurality of the terminal apparatus with a physical communication channel for communicating, establishing a wireless channel with the access point.

13. A communication control method used in communications between a communication network and a plurality of terminal apparatuses which access a plurality of sites connected to the communication network by sharing communication resources of the communication network, the communication control method comprising:
a first step of, when any one of the plurality of terminal apparatuses requests to access any one of the plurality of sites, referring to a priority database for a priority of the site, the priority database storing a plurality of priorities corresponding to the sites, respectively; and
a second step of controlling the communications between the plurality of sites and the plurality of terminal apparatuses, on the basis of the priority referred in the first step.

14. The communication control method according to claim 13, wherein the second step is a step of controlling the transmission speed of the communications on the basis of the priority referred in the first step.

15. The communication control method according to claim 13, wherein the second step is a step of controlling the QoS (Quality of Service) of the communications on the basis of the priority referred in the first step.

16. The communication control method according to claim 13, further comprising a third step of, when the terminal apparatus requests to access a site not stored in the priority database, setting a specified value as a priority for the site.

17. The communication control method according to claim 13, further comprising:
a fourth step of monitoring the states of the plurality of sites; and
a fifth step of updating the contents of the priority database according to the result of the monitoring in the fourth step.

18. The communication control method according to claim 13, further comprising a sixth step of informing the terminal apparatus which has requested the access of the priority referred in the first step.

19. The communication control method according to claim 13, further comprising:
in a case where, when a second terminal apparatus requests to access a specific site, with a communication established between a first terminal apparatus and the specific site, the priority of the communication between the second terminal apparatus and the specific site is higher than the priority of the communication between the first terminal apparatus and the specific site,
a seventh step of cutting off the communication between the first terminal apparatus and the specific site;
an eighth step of setting a communication between the second terminal apparatus and the specific site with a priority higher than the priority of the communication between the first terminal apparatus and the specific site; and
a ninth step of resetting a communication between the first terminal apparatus and the specific site with a priority lower than the priority between the second terminal apparatus and the specific site.

20. The communication control method according to claim 13, further comprising a tenth step of, when a second terminal apparatus requests to access a specific site, with a communication established between a first terminal apparatus and the specific site, rejecting the request.

21. A communication system comprising:
a communication network;
a plurality of sites connected to the communication network;
a plurality of terminals which access the sites by sharing communication resources of the communication network;
a priority database which stores a plurality of priorities set to the sites, respectively; and
control means for controlling communications between the sites and the terminal apparatuses on the basis of the priorities stored in the priority database.
